(19) United States
(12) Patent Application Publication
(10) Pub. No.: US 2024/0248822 A1
(43) Pub. Date: Jul. 25, 2024

(54) GENERATING RANDOMIZED TABULAR DATA

(71) Applicant: Saudi Arabian Oil Company, Dhahran (SA)

(72) Inventor: Badr Al-Dhalaan, Dhahran (SA)

(21) Appl. No.: 18/100,158

(22) Filed: Jan. 23, 2023

(51) Int. Cl. G06F 11/263; G06F 11/36

(52) U.S. Cl. CPC G06F 11/263; G06F 11/3684

(57) ABSTRACT

Systems and methods include a computer-implemented method for generating test data. Configurations are received that define, for each field of a test dataset to be generated, ranges of values for which test values are to be generated for each field. Dependencies are received that define, for each field of the test dataset, relationships with one or more fields and that restrict the test values to be generated for each field of the test dataset. A conditional dependency is received that imposes restrictions on a value range of field X when field Y meets a pre-determined condition. A relational dependency is received that enforces a direct relationship between two or more fields. The relational dependency is in a form of an inequality between field X and field Z. A test data set is generated using the fields, configurations, and dependencies, including generating random test data for each of the configurations.

### TECHNICAL FIELD

The present disclosure applies to generating test data.

### BACKGROUND

A major challenge in the Quality Assurance (QA) step of the application development lifecycle is the lack of suitable test data with which to test computer applications. Currently, software developers typically manually enter rows of data into tables, field-by-field, in order to create test data to test their applications.

Currently, the process of quality assurance test (QAT) requires manual entry of test data in order to test programs that read from SAP tables. For tables with dozens of fields and programs that deal with hundreds of scenarios, such a manual approach is not feasible within the limited timespan of the application development lifecycle. As a result, the testing phase is often largely disregarded due to the lack of quality testing tools for efficient testing. This can lead to poorer quality programs being transported to the production environment, with many bugs that will require significant ongoing support. Not only does this entail man hour costs from the information technology (IT) side, but also service interruption from the user end, which can be very costly. Furthermore, during the process of manually entering data, it can be difficult to keep track of relationships among fields and what constitutes valid field values. Such difficulties are often unmanageable, which can result in a very limited testing phase.

As an example, current solutions that are based on SAP databases, such as data scrambling software, are limited to a very specific subset of standard SAP tables and have no support for custom user made Z-tables. Also, due to the sensitive nature of production data, developers don't typically have free access to copy the data themselves and instead must seek approval from a responsible organization. This process is slow as it adds an extra layer of bureaucracy and is disconnected from the developer.

Current approaches generally require a pre-existing dataset in order to train a model to produce realistic variations of a given sample. A drawback in these approaches is the reliance on an established dataset, thus rendering the approaches incapable of generating novel test data. Even with a pre-existing dataset, these approaches only approximate the original data and therefore don't produce data which strictly adheres to a certain set of rules, thus rendering the process somewhat unsuitable for testing purposes.

### SUMMARY

The present disclosure describes techniques that can be used for the automatic generation of test data. In some implementations, a computer-implemented method includes the following. Configurations are received that define, for each field of a test dataset to be generated, ranges of values for which test values are to be generated for each field. Dependencies are received that define, for each field of the test dataset, relationships with one or more fields and that restrict the test values to be generated for each field of the test dataset. A conditional dependency is received that imposes restrictions on a value range of field X when field Y meets a pre-determined condition. A relational dependency is received that enforces a direct relationship between two or more fields, where the relational dependency is in a form of an inequality between field X and field Z. A test data set is generated using the fields, configurations, and dependencies, including generating random test data for each of the configurations of the fields.

The previously described implementation is implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method, the instructions stored on the non-transitory, computer-readable medium.

The subject matter described in this specification can be implemented in particular implementations, so as to realize one or more of the following advantages. The techniques of the present disclosure can solve the technical problem of automatically creating test data through the systematic generation of random data. The systematic generation is achieved through a system of dependencies and configurations as explained in the present disclosure. The techniques allow for an organized and unified approach to test data generation. Not only do the techniques guarantee the validity and logical consistency of the data, but the techniques have the ability to generate hundreds of rows of tabular data in seconds. This allows a user to test a wide variety of scenarios without the need to manually enter them into a table or other structure. The techniques, therefore, enhance the QA process at all stages, especially useful during development due to the need for continuous testing as part of the agile development model.

Unlike current techniques that are limited to a very specific subset of standard SAP tables, the techniques of the present disclosure do not discriminate between tables in such a way and can generate data for any table. Furthermore, the nature of the data scrambling software in current systems requires data to already exist in the production environment in order to scramble the data and copy the data to the development system. This means that newly created tables must be pushed to production before being tested and therefore cannot make use of such software. However, since the techniques of the present disclosure generate a system's own data from scratch, this is not a limitation for the present disclosure. The techniques of the present disclosure allow the developer to generate any specific set of data by setting up configurations and dependencies in a systematic way. This means that rarer scenarios can be tested just as easily as common ones. In addition, due to the non-deterministic nature of the data generation process, a program used in the present disclosure can be run multiple times under the same configuration to generate different sets of data. This is helpful to ensure robustness of the application being tested on the data. Other solutions, such as the data scrambling software, may provide only a single fixed data set.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF DRAWINGS

FIG. 1 is a screenshot of an example of an initial screen of an auto-table generation application, according to some implementations of the present disclosure.

FIG. 2 is a screenshot of an example of a table definition screen of the auto-table application, according to some implementations of the present disclosure.

FIG. 3 is a screenshot showing an example of the configurations screen of the auto-table application, according to some implementations of the present disclosure.

FIG. 4 is a screenshot showing an example of dependencies screen of the auto-table application, according to some implementations of the present disclosure.

FIG. 5 is a screenshot showing an example of dependencies screen between fields Grade_Code and Salary, according to some implementations of the present disclosure.

FIG. 6 is a screenshot showing an example of dependencies screen between fields Begin_Date and End_Date, according to some implementations of the present disclosure.

FIG. 7 is a flow diagraph showing an example process for a data generation algorithm, according to some implementations of the present disclosure.

FIG. 8 is a flowchart of an example of a method for generating a test data set using the fields, configurations, and dependencies, including generating random test data for each of the configurations of the fields, according to some implementations of the present disclosure.

FIG. 9 is a block diagram illustrating an example computer system used to provide computational functionalities associated with described algorithms, methods, functions, processes, flows, and procedures as described in the present disclosure, according to some implementations of the present disclosure.

Like reference numbers and designations in the various drawings indicate like elements.

### DETAILED DESCRIPTION

The following detailed description describes techniques for automatic generation of test data. Various modifications, alterations, and permutations of the disclosed implementations can be made and will be readily apparent to those of ordinary skill in the art, and the general principles defined may be applied to other implementations and applications, without departing from the scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

The techniques of the present disclosure (known as “AutoTable”) provide a solution to the problems identified in the Background. AutoTable can be implemented as an SAPUI5 web application that provides the ability for a user to automatically generate valid test data for any custom SAP table(s) in the development system. The user can interact with the application through a graphical user interface (GUI) by: 1) inputting the name of a table; 2) configuring the range of values for each field of the table (e.g., Salary>50,000, Begin_Date<2020-01-01); and 3) and defining the dependencies between fields (e.g., Begin_Date<End_Date) before synthetic data is generated and written to an SAP database table. The process defined by these concepts guarantees that the program can efficiently generate valid test data for any table on a large scale.

With AutoTable, data can be generated from scratch according to a set of rules defined by the user in the form of dependencies and configurations. This allows for the generation of valid and logically consistent data for any table, simulating real production data without the need for existing data. As a result, the techniques of the present disclosure provide a software testing tool to be used by developers in the QA process of the development lifecycle.

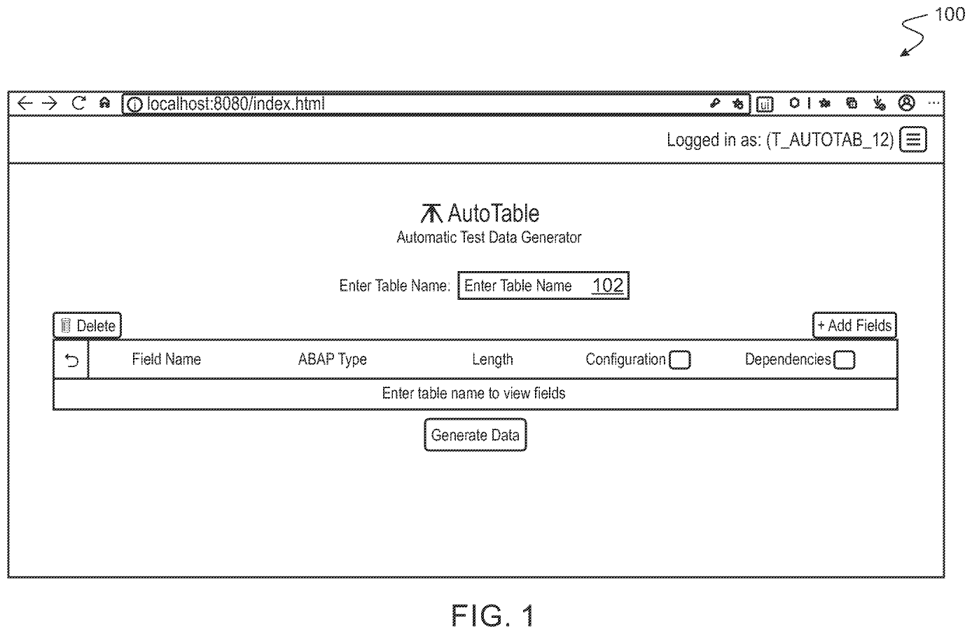

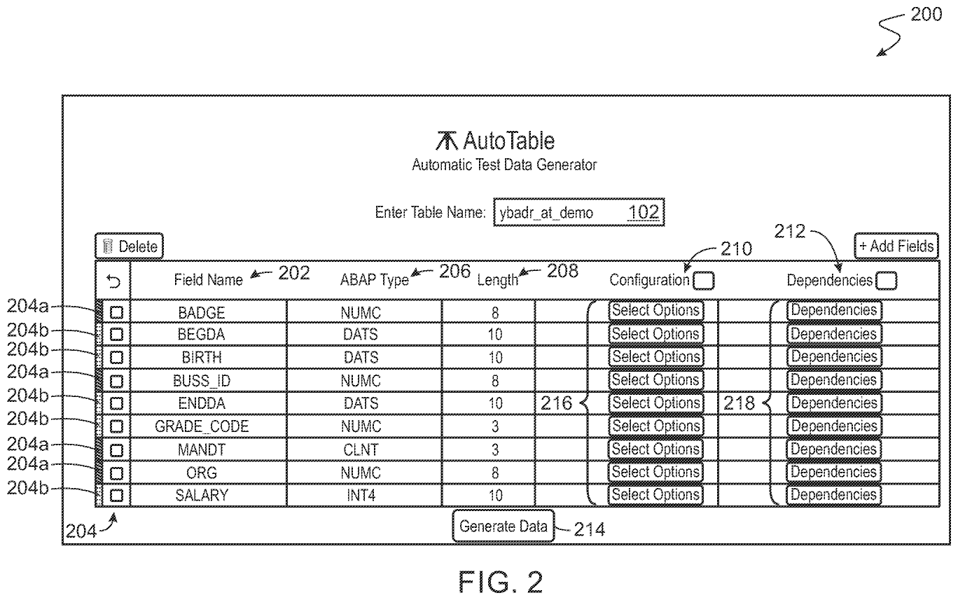

FIG. 1 is a screenshot of an example of an initial screen (or home screen) 100 of an auto-table generation application, according to some implementations of the present disclosure. The user is prompted to enter (or select from a drop-down control) a table name 102 of a table for which test data is to be generated. Once the user identifies a valid table name, the screen of FIG. 2 is shown.

FIG. 2 is a screenshot of an example of table definition screen 200 of the auto-table application, according to some implementations of the present disclosure. The table definition screen 200 displays table fields 202 and associated information for the user-selected table name 102. Each table field 202 of the table has a shaded indicator 204 identifying whether or not the field has an associated value table in the SAP system. If a field dark-shaded indicator 204a, then there exists a table in SAP defining the valid domain of values for that field from which the generated data will come. For example, dark-shaded indicator 204a for file name 202 “ORG” indicates the existence of a table of organization codes that hold all the valid codes for the company. Otherwise, the field is shown in light-shaded indicator 204b indicating no prior information known about the nature of the field other than the field type 206 and length 208. In some implementations, shaded indicators 204a and 204b can instead be color-coded, e.g., green and orange, respectively.

In order to ensure the quality of the data generated, the user can define configurations 210 and dependencies 212 (using the controls shown in FIG. 2) before generating the test data (e.g., using a generate data control 214). Defining the configurations 210 and dependencies 212 can be optional, e.g., if the user wants to proceed to generate data randomly based on data type without defining configurations and dependencies. After selecting the generate data control 214, the user can specify how many rows of test data to generate. Each row in the table of test data contains values for all of the fields. AutoTable can generate data for any datatype, e.g., any datatype in the SAP system.

### Configurations

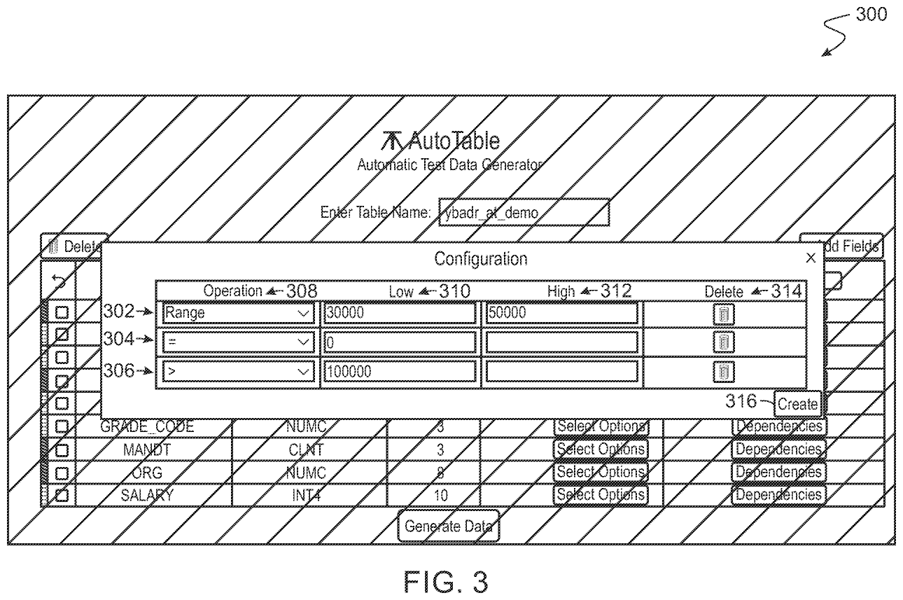

For each field in the table, the user can define a set of one or more configurations which define the range of values that will be generated for that field in the data generation algorithm. After selecting a Select Options control 216 for a field, a window as shown in FIG. 3 is displayed.

FIG. 3 is a screenshot showing an example of configurations screen 300 of the auto-table application, according to some implementations of the present disclosure. The example of FIG. 3 shows a set of configurations defined for the field name 202 of “Salary.” A first row 302 defines a range of integers between 30,000 and 50,000 for the salary field. A second row 304, indicating a second configuration for the field name 202 of “Salary” consists of a single value 0. A third row 306, indicating the third configuration, holds a set of values above 100,000. The union of all three configurations defines the set of values that will be generated for the Salary field at runtime. For example, each row generated in the final table will have a salary that is either between 30,000 and 50,000, or a value of zero, or a salary greater than 100,000. For ranges and for salaries greater than 100,000, the value is chosen at random from between these specified ranges. Other types of configurations are possible, including at least text strings, enumeration types, non-integer values, binary values 0 or 1, Boolean TRUE or FALSE, and values of NULL.

As shown in the example rows 302-306 of FIG. 3, an operation 308 can be Range, =, or >. Other entries are possible, including <, ≤, and ≥. Low value 310 and high value 312 allow ranges to be defined, or single values to be defined, as is the case for second row 304 and third row 306. A delete option 314 allows specific configurations (e.g., rows 302, 304, 306, or other rows) to be deleted.

In general, a configuration consists of three parts: an operation, a low value, and (optionally) a high value. The possible operations are =, <, >, <=, >=, and Range. The first 5 operations are inequalities, which have their typical meaning derived from their mathematical context. Range can be the only operation that makes use of both low and high value fields by defining the set of values between low and high. For many operations, only the “Low” column is typically used. Some examples are listed in Table 1:

TABLE 1
Example Configurations

| Operation | Low | High | Result |
|---|---|---|---|
| >= | 100,000 | N/A | All values (salaries) greater than |
| | | | or equal to 100,000 |
| = | 0 | N/A | Values (salaries) only equal to 0 |
| Range | 30,000 | 50,000 | Salaries between 30,000 and 50,000 |
| | | | (inclusive) |

As previously mentioned, a single field X can have multiple configurations. During the execution of an algorithm that generates test data based on the fields (and recommended configurations and dependencies), one of the configurations Y is randomly selected, and a random value is generated for X based on the value range of Y. This is to ensure that all configurations have equal representation in the data in order to cover all possible scenarios. Individual configurations can be deleted (using delete option 314) and created (using create option 316).

### Dependencies

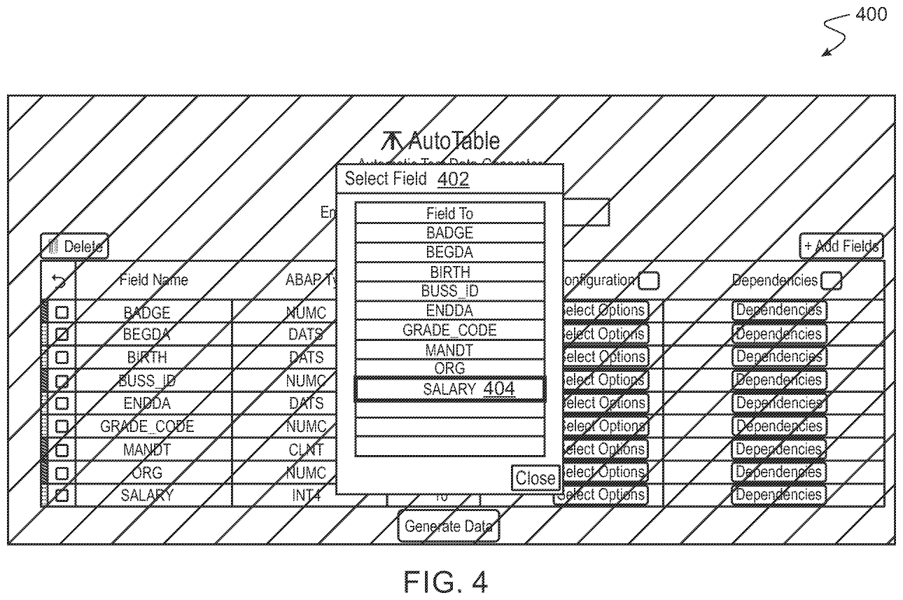

In addition to a set of configurations, each field can have an associated (possibly empty) set of dependencies. A dependency is a relationship between two fields X and Y that restricts the values of field Y based on the generated value of field X. Here, it is said that field Y is dependent on field X. For example, a dependency can be defined as the relationship “Salary>Bonus,” which would ensure that the Bonus value would be less than the Salary value, no matter which value is randomly generated for Salary. In this case, Bonus is dependent on Salary. By clicking on the dependencies button next to a field, a dialog such as shown in FIG. 4 can be displayed.

FIG. 4 is a screen shot showing of an example of dependencies screen 400 of the auto-table application, according to some implementations of the present disclosure. The example dependencies screen 400 screen can appear after selecting a “Dependencies” control 218 for field name 202 “Grade_Code”. The user can use the dependencies screen 400 to define one or more dependent fields for Grade_Code field to another field 402 (e.g., Salary 404) by defining dependencies.

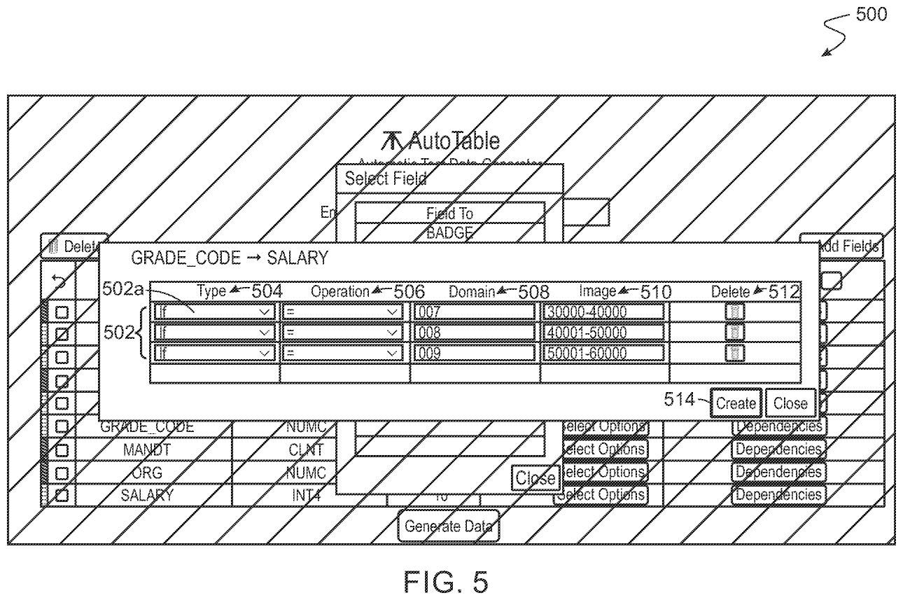

FIG. 5 is a screenshot showing of an example of dependencies screen 500 between fields Grade_Code and Salary, according to some implementations of the present disclosure. The dependencies screen 500 can appear after selecting “Salary” 404 from the dependencies screen 400.

FIG. 5 shows a set of three dependencies 502. In general, for fields X and Y where Y is dependent on X, there are two types 504 of dependencies: conditional dependencies and relational dependencies. Conditional dependencies (if) impose restrictions on the value range of field Y only when field X meets a certain condition. In other words, if the value of field X is equal (operation 506) to one of the values in the Domain 508, then the value generated for field Y will be restricted to the range of the corresponding Image 510. For example, in FIG. 5, if the generated value for Grade_Code is 007, then the value for Salary will be randomly generated from the range of 30,000 to 40,000. Otherwise, there are no additional restrictions on Salary other than what is defined in the Salary configurations. Individual dependencies can be deleted (using delete option 512) and created (using create option 514).

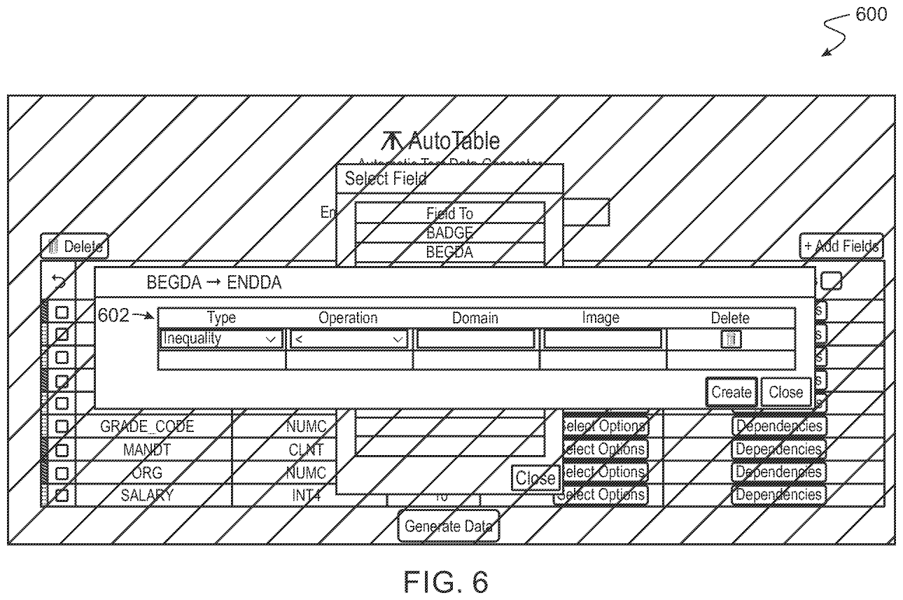

In other cases, relational dependencies can describe a direct relationship between the two fields in the form of an inequality. In this case Operation 506 can be used to define the inequality (one of =, <, <=, >=, >) and the domain/image columns are not used. In FIG. 6, a relational dependency is defined between the fields Begin_Date and End_Date in order to ensure that Begin_Date<End_Date.

FIG. 6 is a screenshot showing an example of dependencies screen 600 between fields Begin_Date and End_Date, according to some implementations of the present disclosure. The user can define a single relational dependency 602 to ensure that BEGDA (begin date) is less than ENDDA (end date).

### Algorithm for Generating Test Data

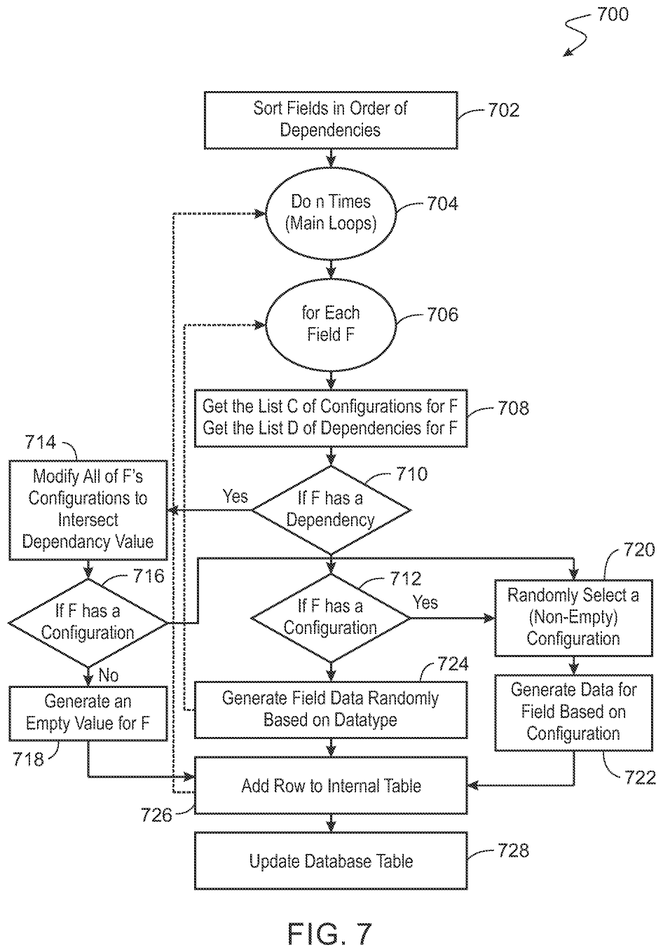

FIG. 7 is a flow diagram showing an example process 700 for a data generation algorithm, according to some implementations of the present disclosure. The full process of the execution of the process 700 and the generation of the data is shown in the below flow chart, illustrating the integration of the concepts defined above. Detailed explanations of the steps are shown below. Steps involving configuration/dependency processing are indicated in dashed lines.

### Sort Fields in Order of Dependencies

The fields are sorted in order from least dependent to most dependent. For example, if X depends on Y, and Y depends on Z, then the ordering would be {Z, Y, X}. This can be achieved, for example, using the Kahn's topological sorting algorithm, where the partial order, in this case, is “X<Y↔Y is dependent on X”. This is a necessary step since it is not possible to generate data for a field F if it is dependent on a field F′ whose value is unknown.

### Combine Sets of Dependencies and Configurations

The configurations and dependencies defined by the user in the main program are retrieved from the database in order to be processed for the data generation algorithm. Next, the main step of the process is to combine the configurations and dependencies in order to ensure that both sets of restrictions are satisfied. For each field f, if f has a configuration, then the set of configurations for f is modified based on f's dependencies. This is done iteratively whereby the process loops through the dependencies and for each satisfied dependency d, loops through the set of configurations in order to modify their ranges. For example, suppose f has a configuration c that is a range from 20,000 to 60,000 as well as a dependency “f<g” where the value of g is 40,000. Then the new modified configuration c′ would be the range from 20,000 to 40,000, thus becoming the intersection of the two. This ensures simultaneously that field f will be within its domain defined in the configuration table and that the relationship between f and g will be as defined by the dependency. However, if the dependency is instead “if g=10,000, f<30,000” then the configuration won't be modified since the antecedent is not true since g is not equal to 10,000. In general, the configuration and dependency are combined in such a way that the end result is a configuration with its range pruned to fit the restriction imposed by the dependency.

If the range of values for c′ becomes empty as a result of this process (that is, the intersection of the dependency and configuration is empty), then c′ is not added into the list of new configurations c′. If c′ is empty (i.e., ranges for all c′ are empty), then an initial value will be generated for f depending on f's datatype.

Once the new set of configurations has been constructed, a single configuration is randomly selected and used to determine the domain of values possible for f. A single such value is chosen at random and assigned to the field f. This process is repeated for each field in the table an n number of times (where n is the number of rows to be generated). Once all the data rows have been generated, the database table is updated with the new entries.

### Summary of User Actions

A summary of a full process from the user's perspective includes the following. The user inputs a table name. The user defines configurations for zero or more fields. The user defines dependencies between zero or more pairs of fields. The user defines a number of rows to generate and presses “Submit.” Once the user completes his input by pressing “Submit”, the main algorithm can commence.

### Main Algorithm

At 702, a list of fields of the table are sorted from least dependent to most dependent to ensure there are no conflicts in data consistency. At 704, a main loop to be performed n times is entered, one time for each row to be generated. At 706, an inner loop is entered for each field F. At 708, a list C of configurations for F defined by user input is obtained, and a list D of dependencies for F defined by user input is obtained. At 710, for each dependency d in D, then at 714, the range of each configuration c is pruned by intersecting the value of d with c.

At 716, if it is determined that the range of c becomes empty as a result, then c is removed from C, and at 718, an empty value is generated for F. At 716, if the set of configurations C becomes empty as a result, then at 718, a random value for F based on type is generated. Otherwise, at 720, a configuration c is randomly selected from C, and at 722, a random value is generated for F based on the range of c. If at 712, it is determined that F does not have a configuration, then at 724, a random value is generated for F based on the data type. At 726, a row is appended to the internal table based on the values of all the fields F.

The process is repeated starting with step 704 an n number of times based on the number of rows to be generated. After the rows are exhausted, at 728, the database table is updated based on the data stored in the internal table.

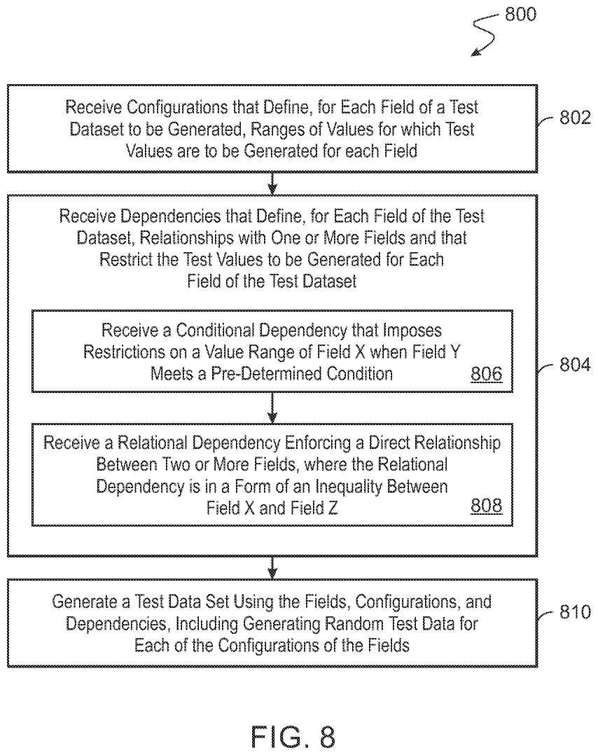

FIG. 8 is a flowchart of an example of a method 800 for generating a test data set using the fields, configurations, and dependencies, including generating random test data for each of the configurations of the fields, according to some implementations of the present disclosure. For clarity of presentation, the description that follows generally describes method 800 in the context of the other figures in this description. However, it will be understood that method 800 can be performed, for example, by any suitable system, environment, software, and hardware, or a combination of systems, environments, software, and hardware, as appropriate. In some implementations, various steps of method 800 can be run in parallel, in combination, in loops, or in any order.

At 802, configurations are received that define, for each field of a test dataset to be generated, ranges of values for which test values are to be generated for each field. The test dataset can be an SAP dataset, for example, as is a focus of examples in the present disclosure. Defining a configuration can consist of defining an operation, a low value, and (optionally) a high value. Example operations include =, <, >, <=, >=, and range. From 802, method 800 proceeds to 804.

At 804, dependencies are received that define, for each field of the test dataset, relationships with one or more fields and that restrict the test values to be generated for each field of the test dataset. Step 804 includes one or both of steps 806 and 808.

At 806, a conditional dependency is received that imposes restrictions on a value range of field X when field Y meets a pre-determined condition (e.g., Salary_Range for Salary_Domain_8 is 40,001 to $50,000).

In some implementations, the configurations and dependencies can be received in a graphical user interface, such as described with reference to FIGS. 1-7. The graphical user interface can facilitate the definition of the configurations and the dependencies and displays actual field names of the test dataset. From 806, method 800 proceeds to 808.

At 808, a relational dependency is received that enforces a direct relationship between two or more fields, where the relational dependency is in a form of an inequality between field X and field Z (e.g., Begin_Date<End_Date). From 804, method 800 proceeds to 810.

At 810, a test data set is generated using the fields, configurations, and dependencies, including generating random test data for each of the configurations of the fields. As an example, generating the test dataset can include pruning a set of values for a configuration based on the dependencies, e.g., as described with reference to step 714 of FIG. 7. After 810, method 800 can stop.

While the examples of the present disclosure describe generating test data to populate, the techniques can be used for non-SAP tables and databases. For example, the same types of algorithms modified with some slight modifications can be repurposed for non-SAP environments such as generating ORACLE database tables or EXCEL worksheets.

Techniques of the present disclosure were piloted and implemented for an oil company. The techniques were tested successfully, and the results were demonstrated to concerned parties.

In some implementations, in addition to (or in combination with) any previously-described features, techniques of the present disclosure can include the following. Outputs of the techniques of the present disclosure can be performed before, during, or in combination with wellbore operations, such as to provide increased quality assurance for software used by and for operation of equipment used for drilling. Examples of wellbore operations include forming/drilling a wellbore, hydraulic fracturing, and producing through the wellbore, to name a few. The wellbore operations can be triggered or controlled, for example, by outputs of the methods of the present disclosure. This is primarily achieved through the increased efficiency that the methods of the present disclosure provide with regards to the application development lifecycle. In some implementations, customized user interfaces can present intermediate or final results of the above described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or “app”), or at a central processing facility. In some implementations, values of parameters or other variables that are determined by techniques of the present disclosure can be used automatically (such as through using rules) to implement changes in oil or gas well exploration, production/drilling, or testing. For example, outputs of the present disclosure can be used as inputs to other equipment and/or systems at a facility in the form of test data for other systems. This can be especially useful for systems which require data in order to train machine learning models.

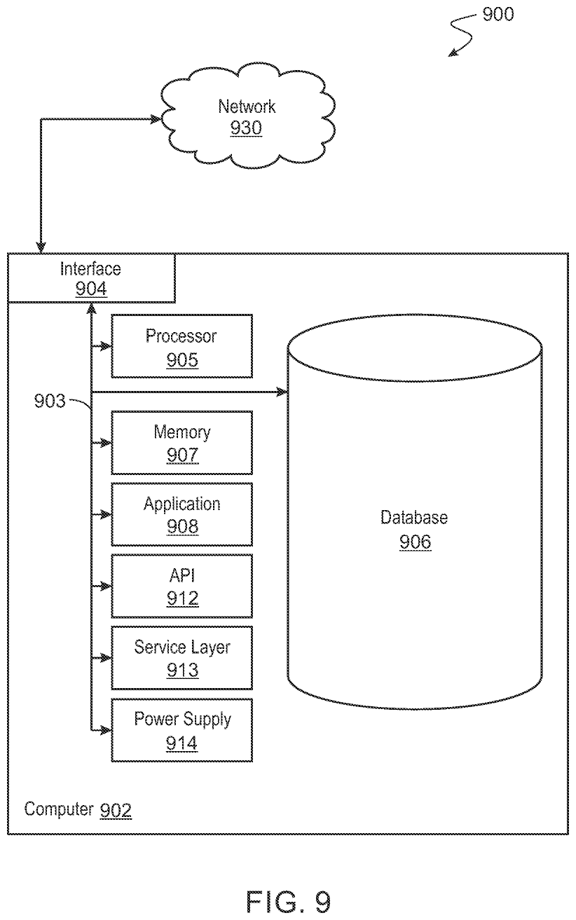

FIG. 9 is a block diagram of an example computer system 900 used to provide computational functionalities associated with described algorithms, methods, functions, processes, flows, and procedures described in the present disclosure, according to some implementations of the present disclosure. The illustrated computer 902 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 902 can include input devices such as keypads, keyboards, and touch screens that can accept user information. Also, the computer 902 can include output devices that can convey information associated with the operation of the computer 902. The information can include digital data, visual data, audio information, or a combination of information. The information can be presented in a graphical user interface (UI) (or GUI).

The computer 902 can serve in a role as a client, a network component, a server, a database, a persistency, or components of a computer system for performing the subject matter described in the present disclosure. The illustrated computer 902 is communicably coupled with a network 930. In some implementations, one or more components of the computer 902 can be configured to operate within different environments, including cloud-computing-based environments, local environments, global environments, and combinations of environments.

At a top level, the computer 902 is an electronic computing device operable to receive, transmit, process, store, and manage data and information associated with the described subject matter. According to some implementations, the computer 902 can also include, or be communicably coupled with, an application server, an email server, a web server, a caching server, a streaming data server, or a combination of servers.

The computer 902 can receive requests over network 930 from a client application (for example, executing on another computer 902). The computer 902 can respond to the received requests by processing the received requests using software applications. Requests can also be sent to the computer 902 from internal users (for example, from a command console), external (or third) parties, automated applications, entities, individuals, systems, and computers.

Each of the components of the computer 902 can communicate using a system bus 903. In some implementations, any or all of the components of the computer 902, including hardware or software components, can interface with each other or the interface 904 (or a combination of both) over the system bus 903. Interfaces can use an application programming interface (API) 912, a service layer 913, or a combination of the API 912 and service layer 913. The API 912 can include specifications for routines, data structures, and object classes. The API 912 can be either computer-language independent or dependent. The API 912 can refer to a complete interface, a single function, or a set of APIs.

The service layer 913 can provide software services to the computer 902 and other components (whether illustrated or not) that are communicably coupled to the computer 902. The functionality of the computer 902 can be accessible for all service consumers using this service layer. Software services, such as those provided by the service layer 913, can provide reusable, defined functionalities through a defined interface. For example, the interface can be software written in JAVA, C++, or a language providing data in extensible markup language (XML) format. While illustrated as an integrated component of the computer 902, in alternative implementations, the API 912 or the service layer 913 can be stand-alone components in relation to other components of the computer 902 and other components communicably coupled to the computer 902. Moreover, any or all parts of the API 912 or the service layer 913 can be implemented as child or sub-modules of another software module, enterprise application, or hardware module without departing from the scope of the present disclosure.

The computer 902 includes an interface 904. Although illustrated as a single interface 904 in FIG. 9, two or more interfaces 904 can be used according to particular needs, desires, or particular implementations of the computer 902 and the described functionality. The interface 904 can be used by the computer 902 for communicating with other systems that are connected to the network 930 (whether illustrated or not) in a distributed environment. Generally, the interface 904 can include, or be implemented using, logic encoded in software or hardware (or a combination of software and hardware) operable to communicate with the network 930. More specifically, the interface 904 can include software supporting one or more communication protocols associated with communications. As such, the network 930 or the interface's hardware can be operable to communicate physical signals within and outside of the illustrated computer 902.

The computer 902 includes a processor 905. Although illustrated as a single processor 905 in FIG. 9, two or more processors 905 can be used according to particular needs, desires, or particular implementations of the computer 902 and the described functionality. Generally, the processor 905 can execute instructions and can manipulate data to perform the operations of the computer 902, including operations using algorithms, methods, functions, processes, flows, and procedures as described in the present disclosure.

The computer 902 also includes a database 906 that can hold data for the computer 902 and other components connected to the network 930 (whether illustrated or not). For example, database 906 can be an in-memory, conventional, or a database storing data consistent with the present disclosure. In some implementations, database 906 can be a combination of two or more different database types (for example, hybrid in-memory and conventional databases) according to particular needs, desires, or particular implementations of the computer 902 and the described functionality. Although illustrated as a single database 906 in FIG. 9, two or more databases (of the same, different, or a combination of types) can be used according to particular needs, desires, or particular implementations of the computer 902 and the described functionality. While database 906 is illustrated as an internal component of the computer 902, in alternative implementations, database 906 can be external to the computer 902.

The computer 902 also includes a memory 907 that can hold data for the computer 902 or a combination of components connected to the network 930 (whether illustrated or not). Memory 907 can store any data consistent with the present disclosure. In some implementations, memory 907 can be a combination of two or more different types of memory (for example, a combination of semiconductor and magnetic storage) according to particular needs, desires, or particular implementations of the computer 902 and the described functionality. Although illustrated as a single memory 907 in FIG. 9, two or more memories 907 (of the same, different, or combination of types) can be used according to particular needs, desires, or particular implementations of the computer 902 and the described functionality. While memory 907 is illustrated as an internal component of the computer 902, in alternative implementations, memory 907 can be external to the computer 902.

The application 908 can be an algorithmic software engine providing functionality according to particular needs, desires, or particular implementations of the computer 902 and the described functionality. For example, application 908 can serve as one or more components, modules, or applications. Further, although illustrated as a single application 908, the application 908 can be implemented as multiple applications 908 on the computer 902. In addition, although illustrated as internal to the computer 902, in alternative implementations, the application 908 can be external to the computer 902.

The computer 902 can also include a power supply 914. The power supply 914 can include a rechargeable or non-rechargeable battery that can be configured to be either user- or non-user-replaceable. In some implementations, the power supply 914 can include power-conversion and management circuits, including recharging, standby, and power management functionalities. In some implementations, the power supply 914 can include a power plug to allow the computer 902 to be plugged into a wall socket or a power source to, for example, power the computer 902 or recharge a rechargeable battery.

There can be any number of computers 902 associated with, or external to, a computer system containing computer 902, with each computer 902 communicating over network 930. Further, the terms “client,” “user,” and other appropriate terminology can be used interchangeably, as appropriate, without departing from the scope of the present disclosure. Moreover, the present disclosure contemplates that many users can use one computer 902 and one user can use multiple computers 902.

Described implementations of the subject matter can include one or more features, alone or in combination.

For example, in a first implementation, a computer-implemented method includes the following. Configurations are received that define, for each field of a test dataset to be generated, ranges of values for which test values are to be generated for each field. Dependencies are received that define, for each field of the test dataset, relationships with one or more fields and that restrict the test values to be generated for each field of the test dataset. A conditional dependency is received that imposes restrictions on a value range of field X when field Y meets a pre-determined condition. A relational dependency is received that enforces a direct relationship between two or more fields, where the relational dependency is in a form of an inequality between field X and field Z. A test data set is generated using the fields, configurations, and dependencies, including generating random test data for each of the configurations of the fields.

The foregoing and other described implementations can each, optionally, include one or more of the following features:

A first feature, combinable with any of the following features, where the test dataset is an SAP dataset.

A second feature, combinable with any of the previous or following features, where the configurations and dependencies are received in a graphical user interface.

A third feature, combinable with any of the previous or following features, where the graphical user interface facilitates definition of the configurations and the dependencies and displays actual field names of the test dataset.

A fourth feature, combinable with any of the previous or following features, where generating the test dataset includes pruning a set of values for a configuration based on the dependencies.

A fifth feature, combinable with any of the previous or following features, where defining a configuration consists of defining an operation, a low value, and (optionally) a high value.

A sixth feature, combinable with any of the previous or following features, where the operation is selected from a group comprising =, <, >, <=, >=, and range.

In a second implementation, a non-transitory, computer-readable medium stores one or more instructions executable by a computer system to perform operations including the following. Configurations are received that define, for each field of a test dataset to be generated, ranges of values for which test values are to be generated for each field. Dependencies are received that define, for each field of the test dataset, relationships with one or more fields and that restrict the test values to be generated for each field of the test dataset. A conditional dependency is received that imposes restrictions on a value range of field X when field Y meets a pre-determined condition. A relational dependency is received that enforces a direct relationship between two or more fields, where the relational dependency is in a form of an inequality between field X and field Z. A test data set is generated using the fields, configurations, and dependencies, including generating random test data for each of the configurations of the fields.

The foregoing and other described implementations can each, optionally, include one or more of the following features:

A first feature, combinable with any of the following features, where the test dataset is an SAP dataset.

A second feature, combinable with any of the previous or following features, where the configurations and dependencies are received in a graphical user interface.

A third feature, combinable with any of the previous or following features, where the graphical user interface facilitates definition of the configurations and the dependencies and displays actual field names of the test dataset.

A fourth feature, combinable with any of the previous or following features, where generating the test dataset includes pruning a set of values for a configuration based on the dependencies.

A fifth feature, combinable with any of the previous or following features, where defining a configuration consists of defining an operation, a low value, and (optionally) a high value.

A sixth feature, combinable with any of the previous or following features, where the operation is selected from a group comprising =, <, >, <=, >=, and range.

In a third implementation, a computer-implemented system includes one or more processors and a non-transitory computer-readable storage medium coupled to the one or more processors and storing programming instructions for execution by the one or more processors. The programming instructions instruct the one or more processors to perform operations including the following. Configurations are received that define, for each field of a test dataset to be generated, ranges of values for which test values are to be generated for each field. Dependencies are received that define, for each field of the test dataset, relationships with one or more fields and that restrict the test values to be generated for each field of the test dataset. A conditional dependency is received that imposes restrictions on a value range of field X when field Y meets a pre-determined condition. A relational dependency is received that enforces a direct relationship between two or more fields, where the relational dependency is in a form of an inequality between field X and field Z. A test data set is generated using the fields, configurations, and dependencies, including generating random test data for each of the configurations of the fields.

The foregoing and other described implementations can each, optionally, include one or more of the following features:

A first feature, combinable with any of the following features, where the test dataset is an SAP dataset.

A second feature, combinable with any of the previous or following features, where the configurations and dependencies are received in a graphical user interface.

A third feature, combinable with any of the previous or following features, where the graphical user interface facilitates definition of the configurations and the dependencies and displays actual field names of the test dataset.

A fourth feature, combinable with any of the previous or following features, where generating the test dataset includes pruning a set of values for a configuration based on the dependencies.

A fifth feature, combinable with any of the previous or following features, where defining a configuration consists of defining an operation, a low value, and (optionally) a high value.

A sixth feature, combinable with any of the previous or following features, where the operation is selected from a group comprising =, <, >, <=, >=, and range.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field-programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, such as LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory.

Graphics processing units (GPUs) can also be used in combination with CPUs. The GPUs can provide specialized processing that occurs in parallel to processing performed by CPUs. The specialized processing can include artificial intelligence (AI) applications and processing, for example. GPUs can be used in GPU clusters or in multi-GPU computing.

A computer can include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/−R, DVD-RAM, DVD-ROM, HD-DVD, and BLU-RAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated into, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that the user uses. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch-screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at the application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations. It should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

What is claimed is:

1. A computer-implemented method, comprising:
receiving configurations that define, for each field of a test dataset to be generated, ranges of values for which test values are to be generated for each field;
receiving dependencies that define, for each field of the test dataset, relationships with one or more fields and that restrict the test values to be generated for each field of the test dataset, including one or more of:
receiving a conditional dependency that imposes restrictions on a value range of field X when field Y meets a pre-determined condition; and
receiving a relational dependency enforcing a direct relationship between two or more fields, wherein the relational dependency is in a form of an inequality between field X and field Z; and
generating a test data set using the fields, configurations, and dependencies, including generating random test data for each of the configurations of the fields.

2. The computer-implemented method of claim 1, wherein the test dataset is an SAP dataset.

3. The computer-implemented method of claim 1, wherein the configurations and dependencies are received in a graphical user interface.

4. The computer-implemented method of claim 3, wherein the graphical user interface facilitates definition of the configurations and the dependencies and displays actual field names of the test dataset.

5. The computer-implemented method of claim 1, wherein generating the test dataset includes pruning a set of values for a configuration based on the dependencies.

6. The computer-implemented method of claim 1, wherein defining a configuration consists of defining an operation, a low value, and (optionally) a high value.

7. The computer-implemented method of claim 6, wherein the operation is selected from a group comprising =, <, >, <=, >=, and range.

8. A non-transitory, computer-readable medium storing one or more instructions executable by a computer system to perform operations comprising:
receiving configurations that define, for each field of a test dataset to be generated, ranges of values for which test values are to be generated for each field;
receiving dependencies that define, for each field of the test dataset, relationships with one or more fields and that restrict the test values to be generated for each field of the test dataset, including one or more of:
receiving a conditional dependency that imposes restrictions on a value range of field X when field Y meets a pre-determined condition; and
receiving a relational dependency enforcing a direct relationship between two or more fields, wherein the relational dependency is in a form of an inequality between field X and field Z; and
generating a test data set using the fields, configurations, and dependencies, including generating random test data for each of the configurations of the fields.

9. The non-transitory, computer-readable medium of claim 8, wherein the test dataset is an SAP dataset.

10. The non-transitory, computer-readable medium of claim 8, wherein the configurations and dependencies are received in a graphical user interface.

11. The non-transitory, computer-readable medium of claim 10, wherein the graphical user interface facilitates definition of the configurations and the dependencies and displays actual field names of the test dataset.

12. The non-transitory, computer-readable medium of claim 8, wherein generating the test dataset includes pruning a set of values for a configuration based on the dependencies.

13. The non-transitory, computer-readable medium of claim 8, wherein defining a configuration consists of defining an operation, a low value, and (optionally) a high value.

14. The non-transitory, computer-readable medium of claim 8, wherein the operation is selected from a group comprising =, <, >, <=, >=, and range.

15. A computer-implemented system, comprising:
one or more processors; and
a non-transitory computer-readable storage medium coupled to the one or more processors and storing programming instructions for execution by the one or more processors, the programming instructions instructing the one or more processors to perform operations comprising:
receiving configurations that define, for each field of a test dataset to be generated, ranges of values for which test values are to be generated for each field;
receiving dependencies that define, for each field of the test dataset, relationships with one or more fields and that restrict the test values to be generated for each field of the test dataset, including one or more of:
receiving a conditional dependency that imposes restrictions on a value range of field X when field Y meets a pre-determined condition; and
receiving a relational dependency enforcing a direct relationship between two or more fields, wherein the relational dependency is in a form of an inequality between field X and field Z; and
generating a test data set using the fields, configurations, and dependencies, including generating random test data for each of the configurations of the fields.

16. The computer-implemented system of claim 15, wherein the test dataset is an SAP dataset.

17. The computer-implemented system of claim 15, wherein the configurations and dependencies are received in a graphical user interface.

18. The computer-implemented system of claim 17, wherein the graphical user interface facilitates definition of the configurations and the dependencies and displays actual field names of the test dataset.

19. The computer-implemented system of claim 15, wherein generating the test dataset includes pruning a set of values for a configuration based on the dependencies.

20. The computer-implemented system of claim 15, wherein defining a configuration consists of defining an operation, a low value, and (optionally) a high value.
